(19) United States
(12) Patent Application Publication
(10) Pub. No.: US 2007/0003684 A1
(43) Pub. Date: Jan. 4, 2007

(54) Reduction of non-enzymatic browning in citrus peel juice

(76) Inventors: Yongsoo Chung, Palatine, IL (US); Osvaldo Chu, Sarasota, FL (US); Thomas Sanders, Parrish, FL (US)

Correspondence Address: PEPSICO, INC.;c/o GOODWIN PROCTER LLP, EXCHANGE PLACE, BOSTON, MA, 02109, US

(21) Appl. No.: 11/170,233

(22) Filed: Jun. 29, 2005

(51) Int. Cl. A23L 2/00

(52) U.S. Cl. 426/599

(57) ABSTRACT

The present invention relates to a method for preparing from concentrate citrus peel juice to reduce non-enzymatic browning. More specifically, the invention relates to adding L-cysteine to the peel juice prior to evaporation and/or pasteurization during processing in order to remove bitterants and thereby retard the aggregate of polyphenolic components. By retarding the accumulation of polyphenolics, the invention inhibits the browning of peel juice.

### BACKGROUND OF THE INVENTION

This invention generally relates to a method for preparing from concentrate citrus peel juice to reduce non-enzymatic browning. More specifically, the invention relates to adding L-cysteine to the peel juice prior to evaporation and/or pasteurization during processing in order to remove bitterants and thereby retard the aggregate of polyphenolic components.

### FIELD OF THE INVENTION

As awareness of the nutritional benefits of consuming citrus fruits has increased, so has the demand for such products. Citrus is an extremely valuable source of nutrition, and has been recognized to aid in the treatment and prevention of disease. Consequently, it is widely believed that the regular consumption of citrus is a beneficial, if not essential, part of maintaining one's health.

The development of a citrus juice industry has led to advancements in the processing of traditional citrus juice. In particular, methods of increasing the desirability of traditionally generated citrus juice by retarding browning and the production of off flavors and colors have been developed. These methods focus primarily on the reduction of browning caused in traditional citrus juice by the oxidation of ascorbic acid and by the reduction of p-vinylguaiacol (PVG) formation.

In addition to improving existing citrus juice products, the citrus juice industry has sought to create quality juice while at the same time minimizing waste. Until recently, little commercial value could be found for the portions of the citrus fruits discarded during juice processing. New developments, however, have uncovered methods of using the discarded peel of the citrus fruits to create a juice suitable for human consumption. Not only does such a process reduce waste, some levels of flavanoids found in citrus peel have been discovered to have health-related properties. (Bocco, et al., 1998). This “peel juice” may be consumed with or without the addition of traditional citrus juice.

The benefits of peel juice are numerous. However, like traditional citrus juice, peel juice is susceptible to browning and the production of off colors and flavors when exposed to time and temperature. Yet, the mechanism of browning in peel juice differs significantly from browning in traditional, not-from-concentrate (NFC) citrus juice. Not only does peel juice contain less ascorbic acid and PVG (the major contributors to browning in citrus juice) than traditional juice, the polyphenolic substrate concentration is nearly ten times higher in peel juice than in NFC citrus juice. Unlike in NFC citrus juice, this polyphenolic concentration is a major cause of browning in peel juice. In order to improve the desirability of peel juice, it is necessary to retard the production of polyphenolics during peel juice processing and thereby inhibit browning. Addressing this concern is a need recognized and answered by the present invention.

Other aspects, objects and advantages of the present invention will be understood from the following description according to the preferred embodiments of the present invention, specifically including stated and unstated combinations of the various features which are described herein, relevant information concerning which is shown in the accompanying drawing.

### SUMMARY OF THE PRESENT INVENTION

The present invention in its broadest sense meets these needs by retarding the aggregate of polyphenolic components in peel juice through the addition of L-cysteine prior to pasteurization and/or evaporation. It has been found that the addition of L-cysteine at this point during the process best reduces non-enzymatic browning in peel juice.

### BRIEF DESCRIPTION OF THE DRAWINGS

FIG. 1 provides a plot of time vs. browning index (O.D. 420 nm) for browning reaction on concentrated peel juice at 15° F.

### DETAILED DESCRIPTION OF THE INVENTION

Citrus peel juice may be prepared by incorporating a number of processes. For example, peel juice may be prepared according to the processes described in the copending application of the assignee of this application, entitled “Citrus Peel Juice,” which is incorporated by reference hereinto. Peel juice of this type is generated by first passing citrus peel byproduct material through a shredding device. The peel is then washed, preferably multiple times. The peel may then be treated by suitable separation technology to reduce suspended solids. During this process, a byproduct is often produced, which may thereafter be sent to a feed mill, or other suitable facility.

Following separation, the resulting raw peel juice can next be pasteurized or subjected to another form of heat treatment. Traditionally, this heat treatment takes place within twenty-four hours of extraction. The raw peel juice may thereafter be filtered such as by microfiltration, debittered, and blended with other juice sources. The peel juice may again be subjected to heat treatment, most often evaporation for concentration of the juice to a substantially reduced water content. This process incorporates what was previously considered waste, to create a highly acceptable beverage when reconstituted by addition of water.

Citrus juices, including peel juice, NFC citrus juice and from concentrate citrus juice experience browning over time and/or when exposed to temperature above freezing. However, the peel juice and other citrus products, particularly NFC juice, are believed to undergo very different browning reactions.

In NFC citrus juices, two mechanisms are thought to be primarily responsible for browning and the development of “off” flavors. The first is the formation of PVG. PVG is thought to form in citrus juice from free ferulic acid due to nonenzymic decarboxylation. Specifically, PVG has been found to increase under storage conditions in traditional orange juice. The second mechanism is the oxidation of ascorbic acid during processing and storage. Both PVG formation and ascorbic acid oxidation are known to contribute to browning in traditionally extracted NFC juice.

Peel juice also suffers from browning. However, peel juice experiences a significantly stronger browning reaction than does NFC citrus juice. This difference is likely due to the fact that the mechanism by which browning takes place in peel juice differs significantly from the NFC browning mechanisms discussed above. The present invention recognizes that treatment of peel juice must differ from treatment of traditional NFC citrus juices.

Unlike in traditional NFC citrus juice, neither oxidation of ascorbic acid nor PVG formation plays a significant, active role in the browning process of peel juice. Primarily, this is because peel juice does not contain as much ascorbic acid as traditional citrus juice. Although the oxidation of ascorbic acid may play a small role, the relatively small amount of ascorbic acid in peel juice indicates that this is not the primary source of browning. Further, PVG formation is of no effect in the browning of peel juice. Instead, the browning seen in peel juice is believed to result from the dramatic increase in polyphenolic substrate.

Nearly ten times the amount of polyphenolic substrate which is found in traditionally extracted citrus juice may be found in peel juice. The large polyphenolic content is likely due to the fact that citrus peels are a bountiful source of phenolic compounds, including phenolic acids and flavanoids. In particular, peel juice contains increased levels of hesperidin, sinensetin, nobilitin, heptamethoxyflavone and tangeritin. These substrates, which include bitterants, cause the peel juice to brown, particularly between the evaporation and pasteurization steps of processing the peel juice. The browning of the peel juice is primarily caused by oxidation of these phenolic compounds. Unlike in traditional citrus juice, it is primarily the sharp increase in polyphenolic substrates that is believed to cause increased browning in peel juice.

The present invention describes the use of L-cysteine to prevent a large extent of the substantial browning that occurs in peel juice. The supplementing of L-cysteine into the juice during the processing of peel juice retards degradation of polyphenolics and thereby slows browning reactions. Phenolic compounds can undergo non-enzymatic oxidation to yield brown pigments. Although not wishing to be bound by any specific operational mechanism, it is believed that L-cysteine prevents brown pigment formation by reacting with quinone intermediates to form stable, colorless compounds. It is further believed that oxidation still occurs in peel juice that is treated with L-cysteine, and the oxidized products react with the L-cysteine to form stable intermediates preventing further formation of brown pigments.

Other aspects, objects and advantages of the present invention will be understood from the following description according to the preferred embodiments of the present invention, specifically including stated and unstated combinations of the various features which are described herein.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

The timing of addition of L-cysteine is also important in the reduction of browning of peel juice. In the present invention, L-cysteine is naturally consumed during the evaporation and/or concentration stages during the processing of peel juice. This consumption leads to the increase in polyphenolics, and therefore browning. By supplementing L-cysteine before a heat treatment such as before a pasteurization stage and/or before an evaporation, or concentration, stage, browning in peel juice is greatly decreased. The supplementation of L-cysteine into peel juice either prior to evaporation, prior to pasteurization, or both prior to evaporation and pasteurization will diminish the browning effects on the peel juice.

L-cysteine may be added within a relatively short period of time before beginning heat processing. Generally, the L-cysteine may be added within one minute of beginning the process. More preferably, the L-cysteine is added within 30 seconds of beginning heat processing treatment. Most preferably, the L-cysteine is added within 10 seconds before beginning heat processing treatment.

Following supplementation with L-cysteine, the peel juice may be blended with other sources, such as from concentrate citrus juice. The enhanced peel juice/citrus juice blend may be created in varying concentrations to allow for taste. Citrus juice may be blended with the peel juice to allow for a beverage comprising from about 1% to about 50% L-cysteine enhanced peel juice. In a preferred embodiment, citrus juice is blended with the peel juice to allow for a beverage comprising from about 5% to about 40% enhanced peel juice. In yet another embodiment, citrus juice is blended with peel juice to allow for a beverage comprising from about 10% to about 30% enhanced peel juice. Citrus juice blends can have about 20% or less of the peel juice treated according to the invention. Unless otherwise stated, the percentages listed herein are by volume and based on the total volume of the juice product.

In the present invention, the L-cysteine may be added at levels slightly above non-supplemented levels in the peel juice. Non-supplemented levels are those levels of L-cysteine that are naturally found in juice. These levels deplete throughout the processing of the juice. Based on USDA nutrient data, orange juice from concentrate contains from approximately 40 ppm of cysteine to approximately 60 ppm of cysteine. It is also reported that there are approximately 280 ppm of cysteine in whole orange with peel. With the assumption of limited consumption of L-cysteine during the processing of peel juice, up to approximately 220 ppm of L-cysteine can be added to juices to claim a lost component during process. Preferably, approximately 0.5 mM (0.0606 g/1000 ml) to approximately 2.0 mM (0.2424 g/1000 ml) of L-cysteine is supplemented during the processing.

Examples of processing according to the invention are presented to illustrate options available.

### EXAMPLE 1

Peel orange juice is prepared by a process including pasteurization. L-cysteine is added at a level of 1.0 mM to the peel juice, immediately prior to pasteurization. The prepared peel juice is combined with from concentrate orange juice (FCOJ) at a ratio of 20% raw peel juice to 80% FCOJ. This mixture is then heat treated to form a concentrated peel juice beverage with reduced non-enzymatic browning.

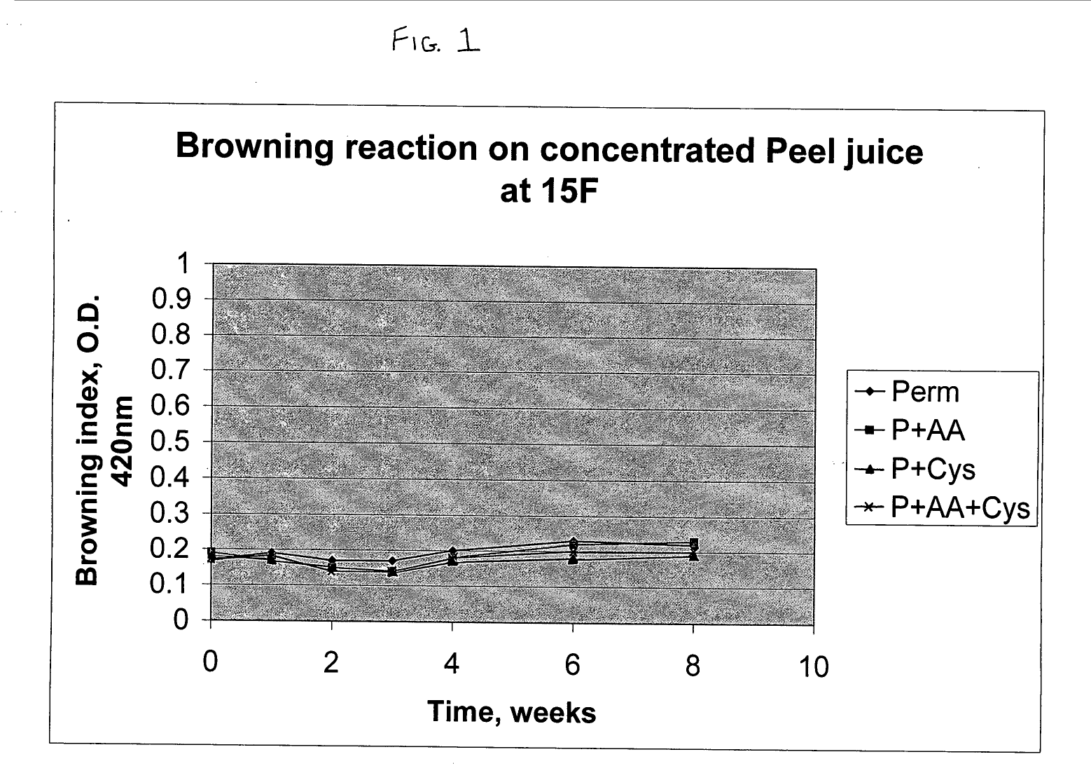

Peel orange juice prepared according to this example with different additives was stored at 15° F. for 8 weeks. The browning index (O.D. 420 nm) vs. time, as plotted in FIG. 1, was lowest for peel juice with L-cysteine added.

### EXAMPLE 2

Peel orange juice is prepared. The prepared peel juice is combined with from concentrate orange juice (FCOJ) at a ratio of 25% raw peel juice to 75% FCOJ. L-cysteine is added at a level of l.OmM to the peel juice, followed immediately by evaporation and concentration to form a concentrated peel juice beverage with reduced non-enzymatic browning.

### EXAMPLE 3

Peel orange juice is prepared by a process including pasteurization. L-cysteine is added at a level of 1.0 mM to the peel juice, immediately prior to pasteurization. The prepared peel juice is combined with from concentrate orange juice (FCOJ) at a ratio of 30% raw peel juice to 70% FCOJ. L-cysteine is then again added at a level of 1.0 mM to the juice mixture, followed immediately by evaporation and concentration. A concentrated peel juice beverage is formed that displays reduced non-enzymatic browning.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. A method for preparing citrus peel juice to reduce non-enzymatic browning, said process comprising:
(a) extracting citrus peel juice from waste peel byproduct of citrus juice extraction from whole fruit, the peel juice including a quantity of polyphenolic components and having L-cysteine present at a non-supplemented level for processing;
(b) adding L-cysteine to the peel juice at from about 0.5 mM to about 2.0 mM above the non-supplemented level of L-cysteine in the peel juice;
(c) thereafter heat processing the peel juice to which L-cysteine has been added; and
(d) blending said L-cysteine enhanced peel juice with from concentrate citrus juice to provide a citrus juice blend,
wherein said L-cysteine above the non-supplemented level minimizes the reaction that creates browning compositions undergone by polyphenolic components during said heat processing to provide citrus peel juice having reduced non-enzymatic browning.

2. The method of claim 1 further comprising the step of debittering said peel juice to remove bitterants and thereby retard the aggregate of polyphenolic components.

3. The method of claim 2 wherein said debittering occurs after said heat processing.

4. The method of claim 2 wherein said debittering occurs prior to said heat processing.

5. The method of claim 2 wherein said debittering occurs both prior to and after said heat processing.

6. The method of claim 1 wherein said L-cysteine above the non-supplemented level is added within 30 seconds of beginning said heat processsing.

7. The method of claim 1 wherein said L-cysteine above the non-supplemented level is added within 10 seconds of beginning said heat processing.

8. The method of claim 1 wherein said heat processing is selected from evaporation and pasteurization.

9. The method of claim 1 wherein said L-cysteine enhanced peel juice constitutes from about 1% to about 50% of the citrus peel juice blend.

10. The method of claim 1 wherein said L-cysteine enhanced peel juice constitutes from about 5% to about 40% of the citrus peel juice blend.

11. The method of claim 1 wherein said L-cysteine enhanced peel juice constitutes from about 10% to about 30% of the citrus peel juice blend.

12. A method for preparing a concentrated citrus peel juice to reduce non-enzymatic browning upon ensuing processing, handling and storage comprising:
(a) preparing citrus peel juice including a quantity of polyphenolic components having L-cysteine present at a non-supplemented level for processing;
(b) treating said citrus peel juice with from about 0.5 to about 2.0 mM of L-cysteine to provide a treated peel juice; and
thereafter evaporating said treated peel juice to produce a concentrated citrus peel juice.

13. The method of claim 12 further comprising extracting said citrus peel juice from waste peel byproduct of citrus juice extraction from whole fruit, the peel juice including a quantity of polyphenolic components and having L-cysteine present at a non-supplemented level for processing.

14. The method of claim 13 wherein said method further includes pasteurizing said peel juice and adding from about 0.5 to about 2.0 mM of L-cysteine above non-supplemented levels to the peel juice within about one minute prior to said pasteurizing.

15. The method of claim 14, further comprising the step of debittering said peel juice to remove bitterants and thereby retard the aggregate of polyphenolic components.

16. The method of claim 15 wherein said debittering occurs after said pasteurizing.

17. The method of claim 15 wherein said debittering occurs prior to said pasteurizing.

18. The method of claim 15 wherein said debittering occurs both prior to and after said pasteurizing.

19. A citrus peel juice made according to the process comprising:
(a) extracting citrus peel juice from waste peel byproduct of citrus juice extraction from whole fruit, the peel juice including a quantity of polyphenolic components and having L-cysteine present at a non-supplemented level for processing;
(b) adding L-cysteine to the peel juice at from about 0.5 mM to about 2.0 mM above the non-supplemented level of L-cysteine in the peel juice;
(c) thereafter heat processing the peel juice to which L-cysteine has been added; and
(d) blending said L-cysteine enhanced peel juice with from concentrate citrus juice to provide a citrus juice blend,
wherein said L-cysteine above the non-supplemented level minimizes the reaction that creates browning compositions undergone by polyphenolic components during said heat processing to provide citrus peel juice having reduced non-enzymatic browning.

20. The citrus peel juice of claim 19 wherein said juice is debittered by reducing bitterants and thereby retarding the aggregate of polyphenolic components.

21. The citrus peel juice of claim 19 wherein said whole fruit is orange fruit, and said from concentrate citrus juice is orange juice.

22. The citrus peel juice of claim 19 wherein said L-cysteine enhanced peel juice constitutes from about 1% to about 50% of the citrus peel juice blend.

23. The citrus peel juice of claim 19 wherein said L-cysteine enhanced peel juice constitutes from about 5% to about 40% of the citrus peel juice blend.

24. The citrus peel juice of claim 19 wherein said L-cysteine enhanced peel juice constitutes from about 10% to about 30% of the citrus peel juice blend.

25. A concentrated citrus peel juice made according to the process of claim 12.
